(19) United States
(12) Patent Application Publication
(10) Pub. No.: US 2025/0300294 A1
(43) Pub. Date: Sep. 25, 2025

(54) ELECTRICITY STORAGE DEVICE AND VEHICLE INCLUDING ELECTRICITY STORAGE DEVICE

(71) Applicant: TOYOTA JIDOSHA KABUSHIKI KAISHA, Toyota-shi (JP)

(72) Inventors: Kazuki SUGIE, Miyoshi-shi (JP); Akio Mori, Toyota-shi (JP); Yoshiro Kamo, Ashigarakami-gun (JP); Takahiko Nakano, Nagoya-shi (JP); Toshihiro Shimonaka, Toyota-shi (JP); Kenichi Kohashi, Sunto-gun (JP); Yuki Soda, Nagoya-shi (JP)

(73) Assignee: TOYOTA JIDOSHA KABUSHIKI KAISHA, Toyota-shi (JP)

(21) Appl. No.: 19/050,299

(22) Filed: Feb. 11, 2025

(30) Foreign Application Priority Data
Mar. 21, 2024 (JP) 2024-045042

(51) Int. Cl. H01M 50/249; B60K 1/04; B60L 50/60; B62D 25/20; H01M 50/204

(52) U.S. Cl. CPC H01M 50/249; B60L 50/66; B62D 25/20; H01M 50/204; B60K 1/04; B60K 2001/0438

(57) ABSTRACT

An electricity storage device is to be disposed below a floor panel of a vehicle. The electricity storage device includes at least one electricity storage cell, an accommodation case that includes an upper case and accommodates the at least one electricity storage cell, an adhesive material provided on an upper surface of the at least one electricity storage cell, the adhesive material causing the at least one electricity storage cell to adhere to the upper case, and at least one buffer member disposed between the upper case and the floor panel and also disposed above the adhesive material.

### CROSS-REFERENCE TO RELATED APPLICATION

This application claims priority to Japanese Patent Application No. 2024-045042 filed on Mar. 21, 2024, incorporated herein by reference in its entirety.

### BACKGROUND

### 1. Technical Field

The present disclosure relates to an electricity storage device and a vehicle including an electricity storage device.

### 2. Description of Related Art

In an electricity storage device (battery pack) disclosed in Japanese Unexamined Patent Application Publication No. 2019-197622 (JP 2019-197622 A), a battery stack including a plurality of electricity storage cells (cells) is restrained by a restraint band made of metal.

### SUMMARY

Incidentally, in the electricity storage device, the electricity storage cell may be fixed not by the restraint band but by an adhesive material. Such an electricity storage device is desired to reduce the usage amount of the adhesive material while the electricity storage cell is fixed.

The present disclosure has one object to reduce the usage amount of the adhesive material while the electricity storage cell is fixed.

An electricity storage device according to one aspect of the present disclosure is to be disposed below a floor panel of a vehicle. The electricity storage device includes at least one electricity storage cell, an accommodation case that includes an upper case and accommodates the at least one electricity storage cell, an adhesive material provided on an upper surface of the at least one electricity storage cell, the adhesive material causing the at least one electricity storage cell to adhere to the upper case, and at least one buffer member disposed between the upper case and the floor panel and also disposed above the adhesive material.

The at least one electricity storage cell may include a plurality of electricity storage cells. Each of the electricity storage cells may be disposed so as to extend in a front-rear direction of the vehicle. The electricity storage cells may be arrayed along a width direction of the vehicle. The at least one buffer member may include a plurality of buffer members. The buffer members may be disposed with an interval in the front-rear direction of the vehicle. Each of the buffer members may be provided so as to extend in the width direction of the vehicle.

The at least one electricity storage cell may include a plurality of electricity storage cells. Each of the electricity storage cells may be disposed so as to extend in the width direction of the vehicle. The electricity storage cells may be arrayed along the front-rear direction of the vehicle. The at least one buffer member may include a plurality of buffer members. The buffer members may be disposed with an interval in the front-rear direction of the vehicle. Each of the buffer members may be provided so as to extend in the width direction of the vehicle.

A vehicle according to another aspect of the present disclosure includes the above-mentioned electricity storage device. The floor panel has a protruding portion that protrudes downward. One of the at least one buffer member is disposed below the protruding portion.

According to the present disclosure, while the electricity storage cell is fixed, the usage amount of the adhesive material can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view schematically illustrating a vehicle including an electricity storage device according to a first embodiment;

FIG. 2 is an exploded perspective view schematically illustrating an electricity storage device 2 and a vehicle framework 3;

FIG. 3 is a perspective view schematically illustrating the electricity storage device 2;

FIG. 4 is a view illustrating an example of an electricity storage cell 10;

FIG. 5 is a first sectional view schematically illustrating a floor panel 4 and the electricity storage device 2;

FIG. 6 is a second sectional view schematically illustrating the floor panel 4 and the electricity storage device 2;

FIG. 7 is a perspective view schematically illustrating an electricity storage device according to a second embodiment; and

FIG. 8 is a sectional view schematically illustrating a floor panel 4 and an electricity storage device 2A.

### DETAILED DESCRIPTION OF EMBODIMENTS

Hereinafter, with reference to the drawings, embodiments and modification examples according to the present disclosure are described. In the following description, like parts and components are denoted by like reference symbols. The same holds true for the names and the functions thereof. Thus, detailed description of those is not repeated. It is to be noted that the embodiments and the modification examples described below may be selectively combined as appropriate.

### First Embodiment

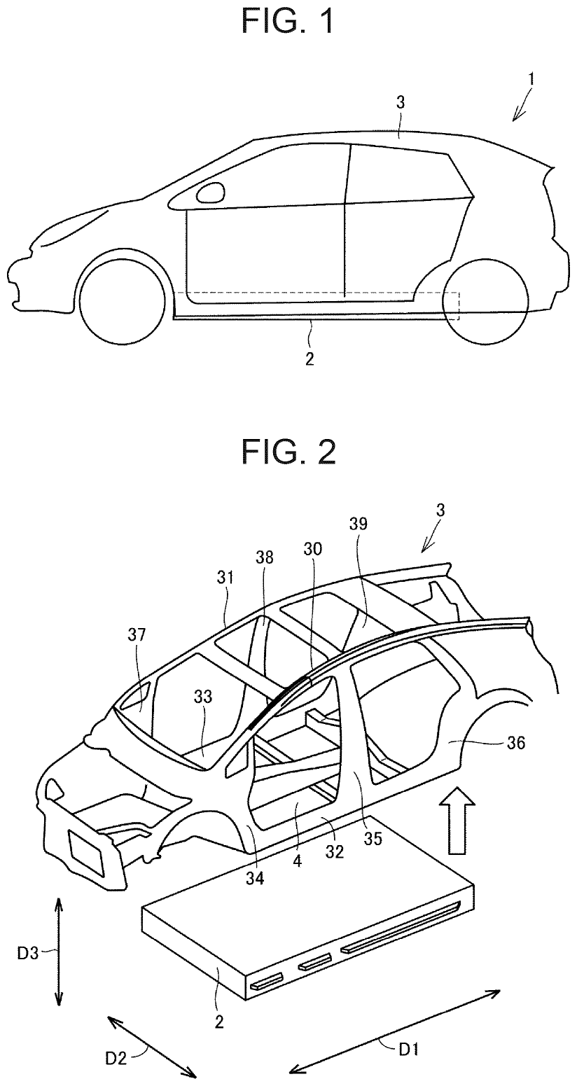

With reference to FIG. 1 to FIG. 6, an electricity storage device according to a first embodiment and a vehicle including the electricity storage device are described. FIG. 1 is a side view schematically illustrating the vehicle including the electricity storage device according to the first embodiment. With reference to FIG. 1, an electricity storage device 2 according to the first embodiment is disposed below a floor panel of a vehicle 1. Examples of the vehicle 1 include a hybrid electric vehicle, a plug-in hybrid electric vehicle, a fuel cell electric vehicle, and a battery electric vehicle. The vehicle 1 includes the electricity storage device 2 and a vehicle framework 3.

FIG. 2 is an exploded perspective view schematically illustrating the electricity storage device 2 and the vehicle framework 3. With reference to FIG. 2, the vehicle framework 3 includes a left roof rail 30, a right roof rail 31, a left frame 32, a right frame 33, a first left pillar 34, a second left pillar 35, a third left pillar 36, a first right pillar 37, a second right pillar 38, and a third right pillar 39.

The left roof rail 30 and the right roof rail 31 are disposed on the upper side of the vehicle framework 3. The left roof rail 30 and the right roof rail 31 are disposed with an interval in a width direction D2 of the vehicle 1 (see FIG. 1). Further, the left roof rail 30 and the right roof rail 31 are disposed so as to extend in a front-rear direction D1 of the vehicle 1. A direction D3 indicates a height direction of the vehicle 1.

The left frame 32 and the right frame 33 are disposed at a bottom portion of the vehicle framework 3. The left frame 32 and the right frame 33 are disposed with an interval in the width direction D2 of the vehicle 1. Further, the left frame 32 and the right frame 33 are disposed so as to extend in the front-rear direction D1 of the vehicle 1.

The first left pillar 34, the second left pillar 35, and the third left pillar 36 are disposed at a left side surface of the vehicle framework 3. The first left pillar 34 is provided so as to connect a front end of the left frame 32 and a front end of the left roof rail 30. The second left pillar 35 is provided so as to connect a center portion of the left frame 32 and a center portion of the left roof rail 30. The third left pillar 36 is provided so as to connect a rear end of the left frame 32 and a rear portion of the left roof rail 30. That is, the second left pillar 35 is disposed rearward of the first left pillar 34 with an interval, and the third left pillar 36 is disposed rearward of the second left pillar 35 with an interval.

The first right pillar 37, the second right pillar 38, and the third right pillar 39 are disposed at a right side surface of the vehicle framework 3. The first right pillar 37 is provided so as to connect a front end of the right frame 33 and a front end of the right roof rail 31. The second right pillar 38 is provided so as to connect a center portion of the right frame 33 and a center portion of the right roof rail 31. The third right pillar 39 is provided so as to connect a rear end of the right frame 33 and a rear portion of the right roof rail 31. That is, the second right pillar 38 is disposed rearward of the first right pillar 37 with an interval, and the third right pillar 39 is disposed rearward of the second right pillar 38 with an interval.

A floor panel 4 is provided between the left frame 32 and the right frame 33. The electricity storage device 2 is disposed below the floor panel 4, and is fixed to the left frame 32 and the right frame 33.

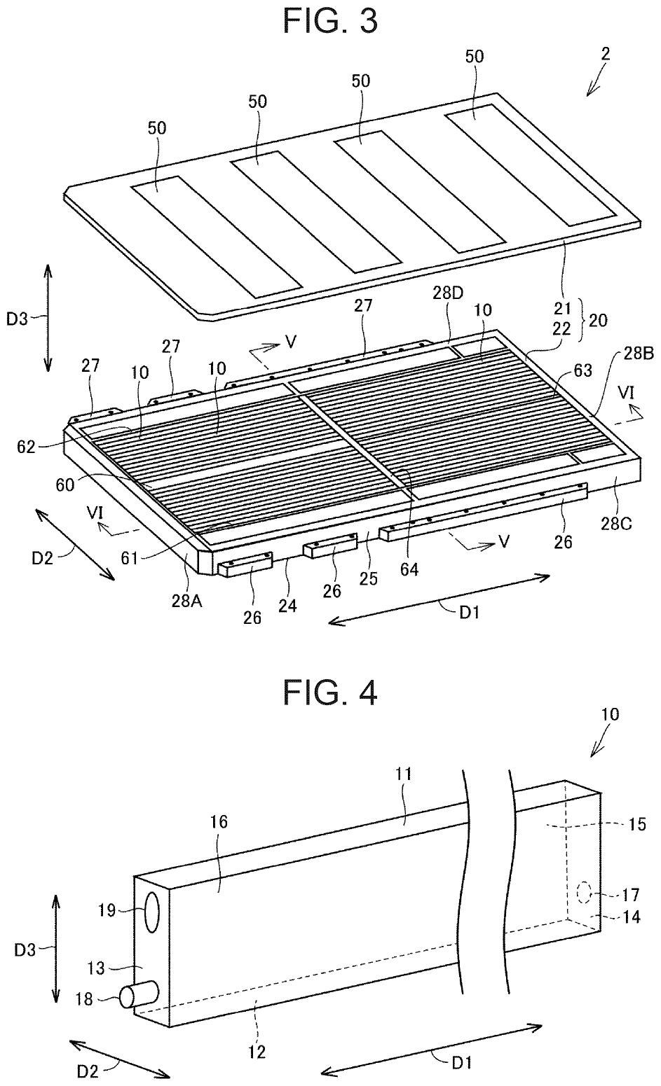

FIG. 3 is a perspective view schematically illustrating the electricity storage device 2. With reference to FIG. 3, the electricity storage device 2 includes a plurality of electricity storage cells 10, and an accommodation case 20 that accommodates the electricity storage cells 10.

The electricity storage cell 10 is a secondary battery, and is typically a lithium-ion secondary battery. The lithium-ion secondary battery is a battery using lithium as a charge carrier, and may include, in addition to a general lithium-ion secondary battery using a liquid electrolyte, what is called an all-solid-state battery using a solid electrolyte. It is to be noted that the electricity storage cell 10 is not limited to the lithium-ion secondary battery, and may be configured of a nickel-hydrogen secondary battery or other secondary batteries.

The electricity storage cell 10 is disposed so as to extend in the front-rear direction D1 of the vehicle 1 (see FIG. 1). Further, the electricity storage cells 10 are arrayed along the width direction D2 of the vehicle 1.

The accommodation case 20 includes an upper case 21 and a lower case 22. FIG. 3 illustrates the electricity storage device 2 in a state in which the upper case 21 is detached. The lower case 22 includes a bottom plate 24, a peripheral wall 25, and a plurality of partition walls 60, 61, 62, 63, 64. The partition walls 60, 61, 62, 63, 64 divide a space in the accommodation case 20 into a plurality of sections.

The bottom plate 24 is formed in a flat plate shape. The peripheral wall 25 is formed so as to extend upward in the vehicle 1 from an outer peripheral edge portion of the bottom plate 24, and the peripheral wall 25 is formed in an annular shape. It is to be noted that the peripheral wall 25 includes a front wall 28A, a rear wall 28B, a left side wall 28C, and a right side wall 28D. The front wall 28A is positioned on the front side of the peripheral wall 25, and the rear wall 28B is positioned on the rear side of the peripheral wall 25. The left side wall 28C and the right side wall 28D are disposed with an interval in the width direction D2 of the vehicle 1. The left side wall 28C is positioned on the left side of the vehicle 1, and the right side wall 28D is positioned on the right side of the vehicle 1. The partition walls 60, 61, 62, 63, 64 are provided on the bottom plate 24. The partition walls 60, 61, 62, 63 are formed so as to extend in the front-rear direction D1 of the vehicle 1, and the partition wall 64 is formed so as to extend in the width direction D2 of the vehicle 1. The partition wall 64 is disposed at the center in the front-rear direction D1 of the vehicle 1. The partition wall 60 and the partition wall 63 are disposed at the center in the width direction D2 of the vehicle 1. The partition wall 60 is disposed forward in the vehicle 1 of the partition wall 64, and the partition wall 63 is disposed rearward in the vehicle 1 of the partition wall 64. A plurality of electricity storage cells 10 is accommodated in each space divided by the partition walls 60, 61, 62, 63, 64.

The lower case 22 further includes a plurality of support portions 26 and a plurality of support portions 27. The support portions 26 are provided on an outer surface of the left side wall 28C of the peripheral wall 25, and the support portions 27 are provided on an outer surface of the right side wall 28D of the peripheral wall 25. The support portions 26, 27 are fixed to the vehicle framework 3 (see FIG. 2). As an example, the support portions 26, 27 have holes into which bolts are fitted. When the bolts are fitted into the holes, the support portions 26 are fixed to the left frame 32 (see FIG. 2), and the support portions 27 are fixed to the right frame 33 (see FIG. 2).

The electricity storage device 2 further includes a plurality of buffer members 50. In the example illustrated in FIG. 3, the electricity storage device 2 includes four buffer members 50. The buffer members 50 are provided on an upper surface of the upper case 21. More specifically, the buffer members 50 are disposed with intervals in the front-rear direction D1 of the vehicle 1. Further, each of the buffer members 50 is formed so as to extend in the width direction D2 of the vehicle 1. When the buffer members 50 and the partition walls 61, 62 are viewed in plan view from above, each buffer member 50 is formed from the partition wall 61 to reach the partition wall 62 in the width direction D2. It is to be noted that each buffer member 50 may be formed from the vicinity of the left side wall 28C to reach the vicinity of the right side wall 28D.

FIG. 4 is a view illustrating an example of the electricity storage cell 10. With reference to FIG. 4, the electricity storage cell 10 includes an upper surface 11, a lower surface 12, a pair of short side surfaces 13, 14, and a pair of long side surfaces 15, 16. The short side surfaces 13, 14 are provided with an interval in the front-rear direction D1 of the vehicle 1. The long side surfaces 15, 16 are disposed with an interval in the width direction D2 of the vehicle 1. Each of the long side surfaces 15, 16 is formed so as to extend in the front-rear direction D1 of the vehicle 1.

The electricity storage cell 10 further includes a positive electrode terminal 17 and a negative electrode terminal 18. The positive electrode terminal 17 is provided on a surface of one of the short side surfaces 13, 14, and the negative electrode terminal 18 is provided on a surface of the other of the short side surfaces 13, 14. In the example illustrated in FIG. 4, the positive electrode terminal 17 is provided on the short side surface 14, and the negative electrode terminal 18 is provided on the short side surface 13. It is to be noted that both of the positive electrode terminal 17 and the negative electrode terminal 18 may be provided on the surface of one of the short side surfaces 13, 14.

The electricity storage cell 10 further includes a cell smoke exhaust valve 19 that exhausts gas in the electricity storage cell 10. The cell smoke exhaust valve 19 is configured to discharge, when the inner pressure of the electricity storage cell 10 rises, the gas inside of the electricity storage cell 10 to the outside of the electricity storage cell 10. The cell smoke exhaust valve 19 is provided in a side surface of the electricity storage cell 10. In the example illustrated in FIG. 4, the cell smoke exhaust valve 19 is provided in the short side surface 13 on which the negative electrode terminal 18 is provided. It is to be noted that the cell smoke exhaust valve 19 may be provided on the short side surface 14, the long side surface 15, or the long side surface 16.

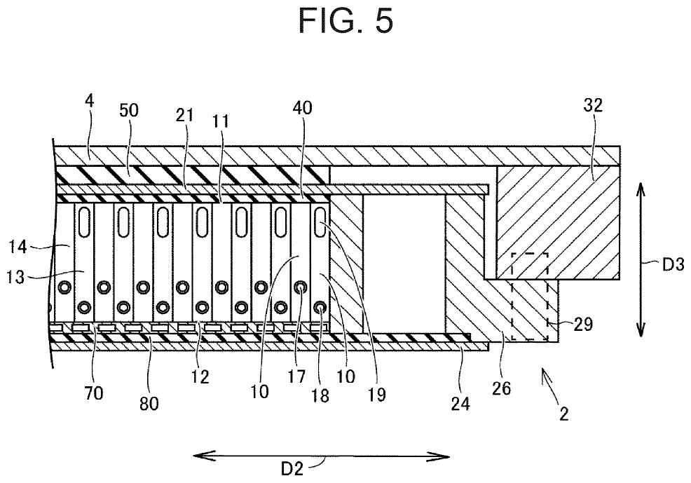

FIG. 5 is a first sectional view schematically illustrating the floor panel 4 and the electricity storage device 2. FIG. 5 illustrates a cross section taken along the line V-V illustrated in FIG. 3 in a state in which the electricity storage device 2 is disposed below the floor panel 4.

With reference to FIG. 5, the electricity storage device 2 is disposed below the floor panel 4. More specifically, a bolt 29 is fitted into the hole provided in the support portion 26, and thus the support portion 26 is fixed to the left frame 32. Although not illustrated in FIG. 5, similarly, a bolt is fitted into the hole provided in the support portion 27 (see FIG. 3), and thus the support portion 27 is fixed to the right frame 33 (see FIG. 2).

In the electricity storage device 2, the electricity storage cell 10 disposed such that the short side surface 13 faces forward in the vehicle 1 (see FIG. 1) and the electricity storage cell 10 disposed such that the short side surface 14 faces forward in the vehicle 1 are alternately disposed along the width direction D2 of the vehicle 1.

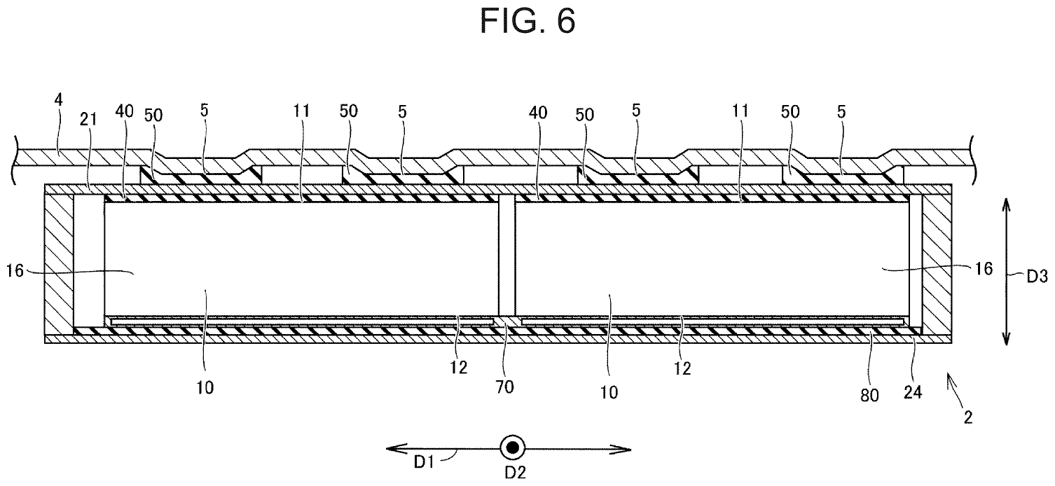

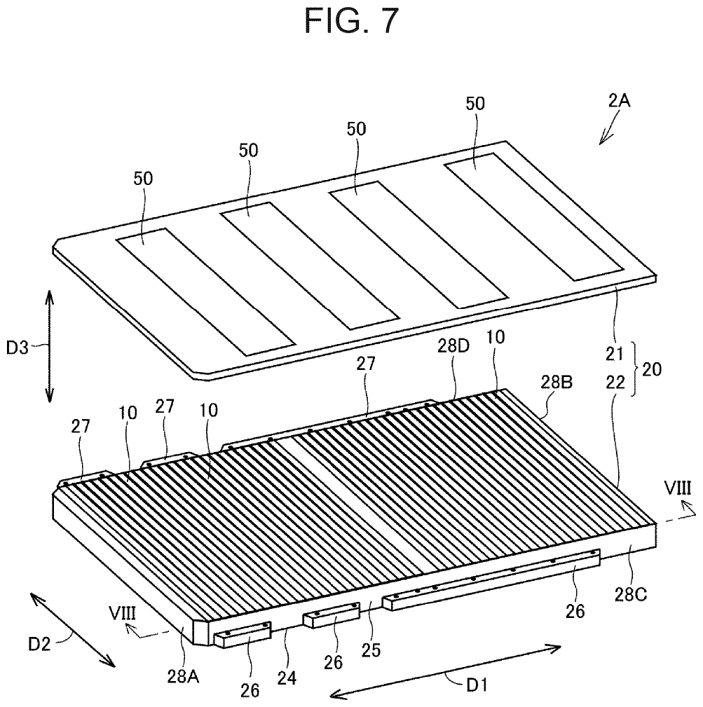

FIG. 6 is a second sectional view schematically illustrating the floor panel 4 and the electricity storage device 2. FIG. 6 illustrates a cross section taken along the line VI-VI illustrated in FIG. 3 in a state in which the electricity storage device 2 is disposed below the floor panel 4.

With reference to FIG. 6, the floor panel 4 has a plurality of protruding portions 5 formed so as to protrude downward in the vehicle 1 (see FIG. 1). In the example illustrated in FIG. 6, the floor panel 4 has four protruding portions 5. The protruding portions 5 are formed with intervals in the front-rear direction D1 of the vehicle 1. Further, each of the protruding portions 5 is formed so as to extend in the width direction D2 of the vehicle 1. It is to be noted that, in the width direction D2, the protruding portion 5 is formed so as to be longer than the buffer member 50.

With reference to FIG. 5 and FIG. 6, the electricity storage device 2 includes an adhesive material 40 that causes the electricity storage cell 10 to adhere to the upper case 21. The adhesive material 40 is made of resin. The adhesive material 40 is provided on the upper surface 11 of the electricity storage cell 10. More specifically, the adhesive material 40 is provided between the upper surface 11 of the electricity storage cell 10 and the upper case 21 and along the upper surface 11. The electricity storage cells 10 are fixed to the upper case 21 by the adhesive material 40.

With reference to FIG. 6, the buffer members 50 are disposed between the upper case 21 and the floor panel 4 with intervals in the front-rear direction D1 of the vehicle 1. More specifically, the buffer members 50 are disposed above the adhesive material 40. Further, the buffer members 50 are disposed below the respective protruding portions 5. That is, the buffer member 50 is disposed below the protruding portion 5, and the adhesive material 40 is provided below the buffer member 50.

With reference back to FIG. 5 and FIG. 6, the electricity storage device 2 further includes a cooler 70 that cools the electricity storage cell 10. The cooler 70 is provided along the lower surface 12 of the electricity storage cell 10.

The electricity storage device 2 further includes an insulating plate 80. The insulating plate 80 is provided between the cooler 70 and the bottom plate 24 and along the bottom plate 24.

As described above, in the electricity storage device 2 according to the first embodiment, the adhesive material 40 is provided on the upper surface 11 of the electricity storage cell 10, and, above the adhesive material 40, the buffer member 50 is provided between the upper case 21 and the floor panel 4. Thus, a load from the floor panel 4 is applied to the buffer member 50, and hence the adhesive material 40 positioned below the buffer member 50 is pressed against the electricity storage cell 10 by the load from the buffer member 50. Accordingly, even when the usage amount of the adhesive material 40 is reduced, the electricity storage cell 10 can be prevented from being separated from the adhesive material 40. Thus, according to the electricity storage device 2 of the first embodiment, the usage amount of the adhesive material 40 can be reduced while the electricity storage cell 10 is fixed.

Further, the floor panel 4 has the protruding portions 5 formed so as to protrude downward in the vehicle 1, and the buffer members 50 are disposed below the respective protruding portions 5. The protruding portion 5 is provided as described above, and hence, as compared to the case in which no protruding portion 5 is provided, the buffer member 50 is pressed against the upper case 21 by the protruding portion 5, and hence the adhesive material 40 positioned below the buffer member 50 is more strongly pressed against the electricity storage cell 10. Accordingly, even when the usage amount of the adhesive material 40 is reduced, the electricity storage cell 10 can be prevented from being separated from the adhesive material 40.

Further, the buffer member 50 is formed so as to extend in the array direction of the electricity storage cells 10 (width direction D2 of the vehicle 1). Accordingly, a load from the floor panel 4 can be applied to the electricity storage cells 10. Accordingly, even when the usage amount of the adhesive material 40 is reduced, the electricity storage cell 10 can be prevented from being separated from the adhesive material 40.

### Second Embodiment

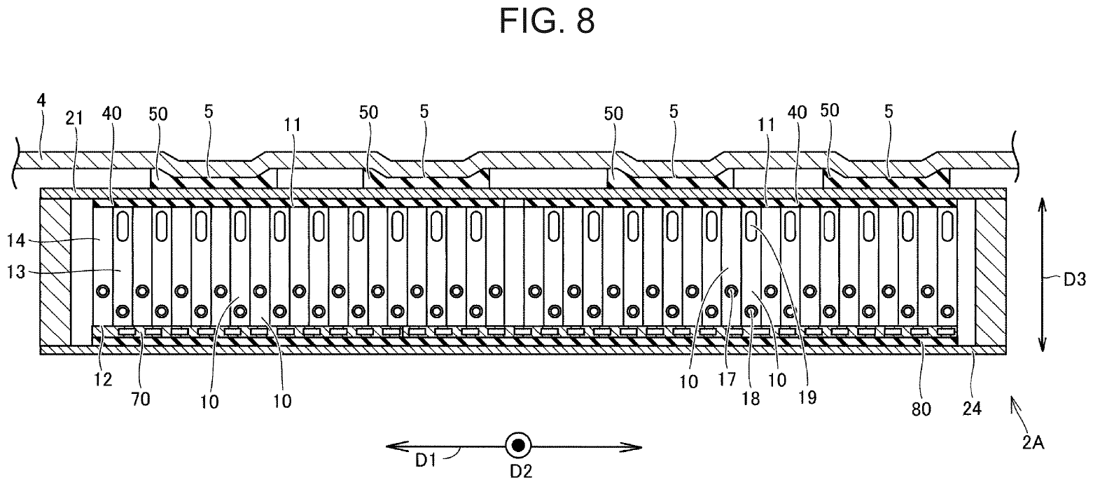

With reference to FIG. 7 and FIG. 8, an electricity storage device according to a second embodiment is described. FIG. 7 is a perspective view schematically illustrating the electricity storage device according to the second embodiment.

An electricity storage device 2A according to the second embodiment is disposed below the floor panel of the vehicle 1 (see FIG. 1) similarly to the electricity storage device 2 according to the first embodiment (see FIG. 3). The electricity storage device 2A according to the second embodiment is different from the electricity storage device 2 according to the first embodiment in the arrangement of the electricity storage cells 10.

In the electricity storage device 2A, the electricity storage cell 10 is disposed so as to extend in the width direction D2 of the vehicle 1, and the electricity storage cells 10 are arrayed along the front-rear direction D1 of the vehicle 1. That is, in the electricity storage device 2A, the short side surfaces 13, 14 (see FIG. 4) are provided with an interval in the width direction D2 of the vehicle 1. Further, the long side surfaces 15, 16 (see FIG. 4) are disposed with an interval in the front-rear direction D1 of the vehicle 1. Further, each of the long side surfaces 15, 16 is formed so as to extend in the width direction D2 of the vehicle 1.

The electricity storage device 2A includes a plurality of buffer members 50 similarly to the electricity storage device 2. In the example illustrated in FIG. 7, the electricity storage device 2A includes four buffer members 50. The buffer members 50 are provided on the upper surface of the upper case 21. More specifically, the buffer members 50 are disposed with intervals in the front-rear direction D1 of the vehicle 1. Further, each of the buffer members 50 is formed so as to extend in the width direction D2 of the vehicle 1. It is to be noted that each buffer member 50 may be formed from the vicinity of the left side wall 28C to reach the vicinity of the right side wall 28D.

FIG. 8 is a sectional view schematically illustrating the floor panel 4 and the electricity storage device 2A. FIG. 8 illustrates a cross section taken along the line VIII-VIII illustrated in FIG. 7 in a state in which the electricity storage device 2A is disposed below the floor panel 4.

With reference to FIG. 8, the electricity storage device 2A is disposed below the floor panel 4. In the electricity storage device 2A, the electricity storage cell 10 disposed such that the short side surface 13 faces leftward in the vehicle 1 (see FIG. 1) and the electricity storage cell 10 disposed such that the short side surface 14 faces leftward in the vehicle 1 are alternately disposed along the front-rear direction D1 of the vehicle 1.

The floor panel 4 has the protruding portions 5 formed so as to protrude downward in the vehicle 1. In the example illustrated in FIG. 8, the floor panel 4 has four protruding portions 5. The protruding portions 5 are formed with intervals in the front-rear direction D1 of the vehicle 1. Further, each of the protruding portions 5 is formed so as to extend in the width direction D2 of the vehicle 1. It is to be noted that, in the width direction D2, the protruding portion 5 is formed so as to be longer than the buffer member 50.

The electricity storage device 2A includes the adhesive material 40 that causes the electricity storage cell 10 to adhere to the upper case 21. The adhesive material 40 is made of resin. The adhesive material 40 is provided on the upper surface 11 of the electricity storage cell 10. More specifically, the adhesive material 40 is provided between the upper surface 11 of the electricity storage cell 10 and the upper case 21 and along the upper surface 11. The electricity storage cells 10 are fixed to the upper case 21 by the adhesive material 40.

The buffer members 50 are disposed between the upper case 21 and the floor panel 4 with intervals in the front-rear direction D1 of the vehicle 1. More specifically, the buffer members 50 are disposed above the adhesive material 40. Further, the buffer members 50 are disposed below the respective protruding portions 5. That is, the buffer member 50 is disposed below the protruding portion 5, and the adhesive material 40 is provided below the buffer member 50.

Further, the electricity storage device 2A further includes the cooler 70 that cools the electricity storage cell 10. The cooler 70 is provided along the lower surface 12 of the electricity storage cell 10.

The electricity storage device 2A further includes the insulating plate 80. The insulating plate 80 is provided between the cooler 70 and the bottom plate 24 and along the bottom plate 24.

As described above, in the electricity storage device 2A according to the second embodiment, the adhesive material 40 is provided on the upper surface 11 of the electricity storage cell 10, and, above the adhesive material 40, the buffer member 50 is provided between the upper case 21 and the floor panel 4. Thus, a load from the floor panel 4 is applied to the buffer member 50, and hence the adhesive material 40 positioned below the buffer member 50 is pressed against the electricity storage cell 10 by the load from the buffer member 50. Accordingly, even when the usage amount of the adhesive material 40 is reduced, the electricity storage cell 10 can be prevented from being separated from the adhesive material 40. Thus, according to the electricity storage device 2A of the second embodiment, the usage amount of the adhesive material 40 can be reduced while the electricity storage cell 10 is fixed.

Further, the floor panel 4 has the protruding portions 5 formed so as to protrude downward in the vehicle 1, and the buffer members 50 are disposed below the respective protruding portions 5. The protruding portion 5 is provided as described above, and hence, as compared to the case in which no protruding portion 5 is provided, the buffer member 50 is pressed against the upper case 21 by the protruding portion 5, and hence the adhesive material 40 positioned below the buffer member 50 is more strongly pressed against the electricity storage cell 10. Accordingly, even when the usage amount of the adhesive material 40 is reduced, the electricity storage cell 10 can be prevented from being separated from the adhesive material 40.

Further, the buffer member 50 is formed so as to extend in the longitudinal direction of the electricity storage cell 10 (width direction D2 of the vehicle 1). Accordingly, a load from the floor panel 4 can be applied to the electricity storage cell 10 positioned below the buffer member 50. Accordingly, even when the usage amount of the adhesive material 40 is reduced, the electricity storage cell 10 can be prevented from being separated from the adhesive material 40.

### Modification Example

The electricity storage devices 2, 2A are each only required to include at least one electricity storage cell 10. Further, the electricity storage devices 2, 2A are each only required to include at least one buffer member 50.

In the first and second embodiments, the floor panel 4 has a plurality of protruding portions 5, but the floor panel 4 may have only one protruding portion 5. When the floor panel 4 has only one protruding portion 5, it is only required that the adhesive material 40 be provided on the upper surface 11 of the electricity storage cell 10, and one of the at least one buffer member 50 be disposed below the protruding portion 5. Further, the remaining buffer member 50 is only required to be provided between the upper case 21 and the floor panel 4 above the adhesive material 40.

Further, the floor panel 4 is not required to have the protruding portion 5. In this case, it is only required that the adhesive material 40 be provided on the upper surface 11 of the electricity storage cell 10, and the at least one buffer member 50 be provided between the upper case 21 and the floor panel 4 above the adhesive material 40.

It should be understood that the embodiments disclosed herein are illustrative and non-restrictive in every respect. The scope of the present disclosure is defined by the terms of the claims, rather than the description above, and is intended to include any modifications within the scope and meaning equivalent to the terms of the claims.

What is claimed is:

1. An electricity storage device to be disposed below a floor panel of a vehicle, the electricity storage device comprising:
at least one electricity storage cell;
an accommodation case that includes an upper case and accommodates the at least one electricity storage cell;
an adhesive material provided on an upper surface of the at least one electricity storage cell, the adhesive material causing the at least one electricity storage cell to adhere to the upper case; and
at least one buffer member disposed between the upper case and the floor panel and also disposed above the adhesive material.

2. The electricity storage device according to claim 1, wherein:
the at least one electricity storage cell includes a plurality of electricity storage cells;
each of the electricity storage cells is disposed so as to extend in a front-rear direction of the vehicle;
the electricity storage cells are arrayed along a width direction of the vehicle;
the at least one buffer member includes a plurality of buffer members;
the buffer members are disposed with an interval in the front-rear direction of the vehicle; and
each of the buffer members is provided so as to extend in the width direction of the vehicle.

3. The electricity storage device according to claim 1, wherein:
the at least one electricity storage cell includes a plurality of electricity storage cells;
each of the electricity storage cells is disposed so as to extend in a width direction of the vehicle;
the electricity storage cells are arrayed along a front-rear direction of the vehicle;
the at least one buffer member includes a plurality of buffer members;
the buffer members are disposed with an interval in the front-rear direction of the vehicle; and
each of the buffer members is provided so as to extend in the width direction of the vehicle.

4. A vehicle comprising the electricity storage device of claim 1, wherein:
the floor panel has a protruding portion that protrudes downward; and
one of the at least one buffer member is disposed below the protruding portion.
